(19) United States
(12) Patent Application Publication
(10) Pub. No.: US 2005/0077992 A1
(43) Pub. Date: Apr. 14, 2005

(54) Symmetric planar inductor

(76) Inventors: Gopal Raghavan, THOUSAND OAKS, CA (US); Michael G. Case, THOUSAND OAKS, CA (US)

Correspondence Address: LADAS & PARRY, 5670 WILSHIRE BOULEVARD, SUITE 2100, LOS ANGELES, CA, 90036-5679, US

(21) Appl. No.: 10/666,532

(22) Filed: Sep. 19, 2003

Related U.S. Application Data
(60) Provisional application No. 60/412,283, filed on Sep. 20, 2002.

(51) Int. Cl. H01F 5/00

(52) U.S. Cl. 336/200

(57) ABSTRACT

A substantially symmetric inductor comprising a plurality of windings, at least one conductor crossover, and a peripheral conductor disposed at the periphery of the plurality of windings, the plurality of windings having a generally symmetric shape, each of the plurality of windings having a center and being of a different size from other ones of the plurality of windings, the peripheral conductor being generally symmetric and having a center, the plurality of windings and the peripheral conductor being substantially concentric, the conductor crossovers being disposed such that the symmetry of the inductor in substantially preserved. A method of winding an inductor such that the inductor is substantially symmetric about a center of the inductor, whereby signal degradation due to asymmetry of the inductor is substantially minimized.

### CROSS REFERENCE TO RELATED APPLICATION

This application claims the benefit of U.S. Patent Provisional Patent Application Ser. No. 60/412,283 filed Sep. 20, 2002, the disclosure of which is hereby incorporated herein by reference.

### TECHNICAL FIELD

This invention relates to the field of inductors which are used in integrated circuits. In particular, this invention relates to symmetric inductors particularly adequate for use in circuits using differential signals. The inductors winding preferably have either a spiral or a spiral-like planar configuration.

### BACKGROUND OF THE INVENTION

Patents relating to inductors abound in the prior art. However, most such patents refer to standard, asymmetric spiral inductors, and disclose various methods of improving characteristics of these spiral inductors, such as increasing Q=Wₛ/W_{d} (where Wₛ is the energy stored and W_{d} is the energy dissipated in the inductor per cycle) or reducing the size of the inductors. Examples of inductor patents are U.S. Pat. No. 3,765,082 relating to a method of making an inductor chip, U.S. Pat. No. 5,656,849 relating to a two-level spiral inductor structure having a high inductance to area ratio, U.S. Pat. No. 5,805,043 relating to a high Q compact inductors for monolithic integrated circuit applications, U.S. Pat. No. 5,793,272 relating to an integrated circuit toroidal inductor, U.S. Pat. No. 5,884,990 relating to an integrated circuit inductor, U.S. Pat. No. 6,008,713 relating to a monolithic inductor, U.S. Pat. No. 6,054,329 relating to a method of forming an integrated circuit spiral inductor with ferromagnetic liner, and U.S. Pat. No. 6,013,939 relating to a monolithic inductor with magnetic flux lines guided away from substrate.

Planar spiral inductors have been used for integrated circuits since the early 1970's. Such spiral inductors have been designed with an intrinsic asymmetry since one terminal of the inductor is at the outside of the spiral, while the other terminal is on the inside. This asymmetry usually does not have any substantial effects on circuits using single-ended signals, i.e., where the signal voltage is relative to ground or a fixed potential. However, many new circuits and systems use differential signals where the signal voltage is the difference between two terminals. Any asymmetry in circuits using differential signals (differential circuits) has the effect of degrading the signal quality, and is thus very undesirable.

FIG. 1 shows a conventional planar spiral inductor 7 commonly found in the prior art. The general shape of the spiral inductor may be rectangular as in FIG. 1, circular, etc. This configuration is such that terminal 1 is connected to the inside 6 of the spiral 7, while terminal 2 is connected to the outside 5 of the spiral 7. This significant difference between terminal 1 and terminal 2 creates asymmetry in the spiral inductor. Further, this configuration requires the conductor 8 leading to the center of the spiral to cross over (or under) the intervening winding(s) 9, further increasing the asymmetry of the inductor and adding undesired capacitive coupling.

The present invention addresses the above-noted problems encountered in the prior art. In particular, the present invention addresses signal degradation due to inductor asymmetry and conductor cross-over capacitive effects, by providing a symmetric spiral inductor and a method of making such spiral inductor.

### BRIEF DESCRIPTIONS OF THE INVENTION

In one aspect, the present invention relates to a inductor which is substantially symmetric and thus does not exhibit signal degradations due to asymmetry of the inductor. The symmetric inductor comprises concentric windings of different sizes or effective diameters, and winding crossovers which are disposed in such a way that the symmetry of the inductor is preserved. In this way, capacitive effects caused by conductor crossovers, are substantially minimized. The indictor is preferably of a spiral or spiral-like configuration and is preferably disposed on a planar substrate.

In another aspect, the present invention relates to a method of winding an inductor as concentric circles, rectangles, squares or other generally symmetric shapes, rather than a true spiral. The magnetic field coupling and inductive coupling needed for enhanced inductance is maintained, while providing a substantially symmetric structure. Furthermore, conductor crossovers can be symmetrically placed, preserving the symmetry of the structure and minimizing undesirable capacitive coupling.

### BRIEF DESCRIPTION OF THE DRAWINGS

FIG. 1 shows a conventional planar spiral inductor of the prior art.

FIG. 2 shows a symmetric planar spiral inductor in accordance with the present invention, wherein concentric circles are used to wind the inductor instead of a spiral.

FIG. 3 shows a symmetric planar spiral inductor in accordance with the present invention, wherein the inductor comprises a large number of square windings.

FIG. 4 illustrates an equivalent circuit to the planar spiral inductor in accordance with the present invention.

FIG. 5 is a comparative table showing the results of a simulation of the inductor of FIG. 1 and the inductor of FIG. 2.

### DETAILED DESCRIPTION OF THE INVENTION

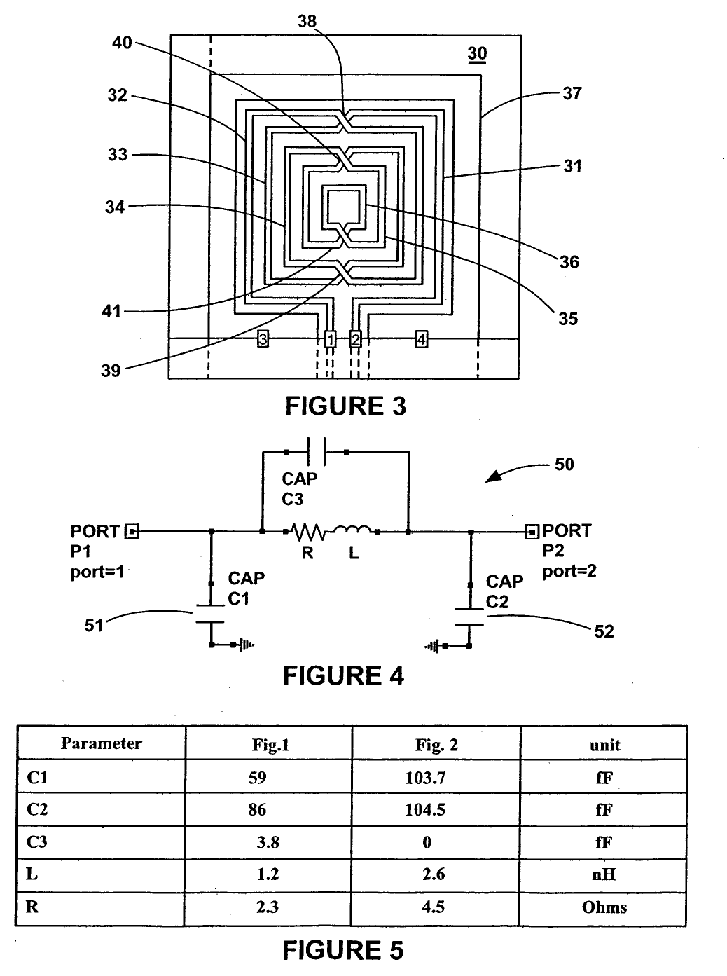

Referring to FIG. 2, a planar symmetric inductor 20 in accordance with an embodiment of the present invention is shown. A planar inductor is an inductor whose plurality of windings preferably occupy a common plane except for the cross-over or cross-under points. The inductor 20 can be connected to other components of a circuit by terminal 1 and terminal 2, while terminal 3 and terminal 4 are ground terminals. The inductor 20 comprises an inductor winding 25 made of a conductive material, the winding 25 including concentric outer circular winding 22 and inner circular winding 23. The inductor 20 also comprises a circular peripheral conductor 21 which forms a ground plane that terminates the electric fields and makes the inductor 20 a guided wave structure. The circular peripheral conductor 21 is concentric with circular windings 22 and 23 and has diameter greater than that of circular windings 22 and 23. As shown in FIG. 2, peripheral conductor 21 is preferably disposed at the periphery of circular windings 22 and 23.

The path taken by the electrical current within the inductor winding 25 illustrates the fashion in which the windings 22 and 23 are formed and how the inductor may be fabricated. Starting at terminal 1 and traveling clockwise, the electrical current may travel through the left half 22L of the outer winding 22 and reaches conductor crossover 24 again. The conductor crossover 24 conductively connects the left half 22L of the outer winding 22 to right half 23R the inner winding 23. After crossing over, the current continues to travel clockwise through the right half 23R of inner winding 23, and then the left half 23L of the inner winding 23 to reach crossover 24. After crossing under, the current continues to travel clockwise through the right half 22R of outer winding 22, to finally reach terminal 2. Obviously, the electrical current may also travel counter clockwise within the inductor winding 25, by entering the inductor at terminal 2 and exiting at terminal 1. The foregoing description of the path taken by the electrical current is for the purpose of illustrating how the windings of the inductor are disposed, in accordance with one embodiment of the present invention.

To facilitate understanding of the configuration of the inductor winding 25, only two windings 22 and 23 are shown in FIG. 2. However, as many windings as necessary may be used to form the inductor winding. It should now be evident to the skilled person to add or subtract windings using the same general method of winding described in connection with FIG. 2. The number of windings will generally be dictated by the desired characteristics for the inductor.

In the example of FIG. 2, the symmetric inductor preferably has a diameter of about 450 μm, but values between about 350 μm and 550 μm are also adequate. Other values which achieve the desired results will be apparent to the skilled person. The diameter of outer winding 22 may range from about 250 to 450 μm, while the diameter of winding 23 may range from about 230 to 430 μm. The width of each winding is preferably controlled to +/−0.2 μm. The range of the widths of the windings is generally 2 μm to 50 μm, however, the widths may even be greater than 50 μm. The widths is chosen on the basis of the maximum current that must be carried by the winding.

The use of concentric circular windings affords the inductor a symmetrical configuration, eliminating signal degradation due to inductor asymmetry. In order for the center of one winding to substantially coincide with the center of other windings, the location of the centers of each winding are preferably controlled to +/−0.05 μm or better. Further, conductor crossovers are preferably disposed to best preserve the symmetry of the inductor. As shown in FIG. 2, the only crossover is preferably placed diametrically opposite terminals 1 and 2. If a third winding was to be added to the inductor of FIG. 2, a second crossover would preferably be placed diametrically opposite crossover 24, near terminals 1 and 2. By disposing crossovers in this fashion, capacitive effects at the crossovers are minimized. One skilled in the art will appreciate that the crossovers could be placed anywhere in the winding; however, as the cross-overs, or cross-unders, are moved symmetry of the device will be affected.

Turning to FIG. 3, a symmetric inductor 30 using a large number of square windings is shown. The symmetric inductor 30 is, in most respects, similar to the circular symmetric inductor 20 of FIG. 2, except for the shape and number of windings used. In the example of FIG. 3, the symmetric inductor 30 comprises a square peripheral conductor 37, and an inductor winding 31. The inductor winding 31 comprises 5 square windings 32, 33, 34, 35 and 36, the square windings sharing a common center of symmetry, i.e. within +/−0.05 μm. The square peripheral conductor 37 also shares this common center symmetry with the square windings. A side of the peripheral conductor 37 is greater than the side of a largest winding 32, such that the peripheral conductor 37 is disposed at the periphery of the inductor winding 31. The length of one side of the square peripheral conductor 37 may range from about 37 μm to about 300 μm, wherein, once the length of one side of the square is chosen, the lengths of the other sides are controlled within +/−0.2 μm. The range of the widths of the windings is generally 2 μm to 50 μm, however, the widths may even be greater than 50 μm. The widths are chosen on the basis of the maximum current that must be carried by the winding.

Again, the path taken by the electrical current within the inductor winding 31 illustrates the fashion in which windings 32, 33, 34, 35, and 36 are formed and how the inductor may be fabricated. Starting at terminal 1 and traveling clockwise, the electrical current may travel through the left half of winding 32, to then cross over at conductor crossover 38, to the right half of winding 33. After crossing over at cross over 39 to the left half of winding 34, the current continues on to cross over 40. After crossing over, the current travels through the right half of winding 35 to cross over 41 where is crosses over to the innermost winding 36. The current then travels through winding 36 back to crossover 41 where it crosses under to the left half of winding 35. It then crosses under at crossover 40 to travel through the right half of winding 34, to then cross under at crossover 39 to the left side of winding 33. After crossing under at crossover 38, the current travels through the right side of winding 32 to finally reach terminal 2.

The use of square windings which share a common center, affords the inductor a symmetrical configuration, eliminating signal degradation due to inductor asymmetry. In order for the center of one winding to substantially coincide with the center of other windings, the location of the centers of each winding are preferably controlled to +/−0.05 μm or better. Further, conductor crossovers are preferably disposed to best preserve the symmetry of the inductor. As shown in FIG. 3, in the case of square windings, the crossovers are preferably placed on an axis intersecting the conductor crossovers and the center of the conductor. In this way, the symmetry of the inductor is preserved and capacitive coupling effects at crossovers are minimized. The number of windings used in the in the inductor winding may vary and will mainly depend on the desired characteristics for the inductor.

When a conductor crosses over another conductor at the crossovers, the two conductors are insulated from each other. In the foregoing description one conductor is described as passing “over” the other conductor which is described as passing “under.” However, so long as the two conductors are insulated from one another, either one can pass “over” or “under” the other conductor at the crossovers.

Although described in the case of circular and square windings, any concentric arrangement of arbitrarily symmetric shapes may be used. Such other shapes may include, but are not limited to, hexagons, rectangles, ellipses, etc. In order to for the center of one winding to substantially coincide with the center of other windings, the location of the centers of each winding are preferably controlled to +/0.05 μm or better.

A typical number of windings included in the inductor of the present invention may be between 2 and 5 and the corresponding inductance may range between about 1 and 8 nH. However, as would be apparent to the skilled person, any number of concentric windings may be used to obtain the desired value of inductance.

The spacing between two adjacent windings preferably ranges from about 5 μm to about 15 μm. However, other spacings may also be adequate as would be apparent to the skilled person. The spacing between confronting edges of adjacent windings, excluding the crossover points, are preferably constant and should not vary by more than +/0.4 μm, thereby causing the windings to be generally symmetric one to another.

Inductors in accordance with the present invention, are particularly adequate for use in circuits using differential signals, such as oscillators, mixers and amplifiers. However, they can be used in any circuit where inductors are needed. Inductors in accordance with the present invention may be manufactured as part of an integrated circuit. One skilled in the art will appreciate that there are many techniques used to manufacture inductors as a part of integrated circuits. The inductors shown in FIGS. 2 and 3 are manufactured in the same manner other inductors that are part of integrated circuits are manufactured. For example, the inductor may be manufactured by defining a pattern in photoresist, then plating the windings and using a lift off technique to define windings (except for the portion crossing over at the crossovers). Alternatively, the metal may be put down and then pattern using conventional photolithographic techniques well known in the semiconductor fabrication art. In either case, a suitable insulating layer is put down over the patterned metal layer and the insulating layer is patterned to provide access to the distal ends of a partially complete winding formed by an inner winding half and an outer winding half A second metal layer to be put down and patterned to form the missing portion crossing over at the crossovers and which connect to the distal ends of the aforementioned partially complete winding.

Any material with suitably low RF loss can be used as the substrate. InP and GaAs are preferable when the inductor is integrated with circuitry. When the inductor is not integrated with circuitry, then alumina or any number of ceramic or glass substrates can be used without loss of performance.

One skilled in the art will appreciate that the inductors of the present invention may be manufactured by any semiconductor process which allows the patterning of two layers of metal. Therefore, the present invention is independent of the semiconductor process used.

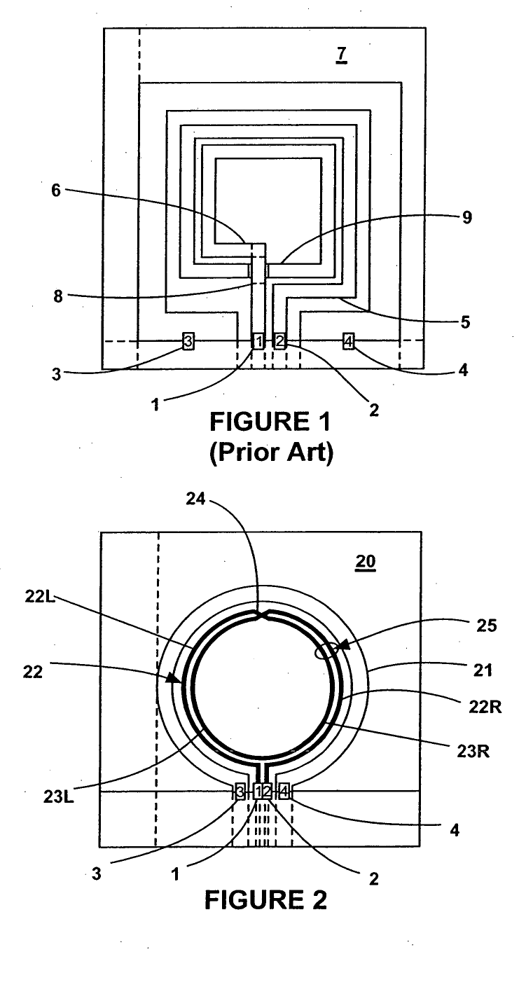

A typical equivalent circuit 50 for a planar spiral inductor is shown in FIG. 4. Asymmetry appears as a difference between the capacitance C1 of capacitor 51 and the capacitance C2 of capacitor 52. If the circuit is perfectly symmetric, then C1=C2. An electromagnetic simulator was used to model the behavior of the prior art spiral inductor of FIG. 1, as well as the symmetric inductor of the present invention shown in FIG. 2. The equivalent circuit parameters were then fit to match the characteristics of both inductors. FIG. 5 shows a table which provides equivalent circuit parameters fit to the electromagnetic simulations of the inductors shown in FIGS. 1 and 2. In the case of the prior art inductor of FIG. 1, the table of FIG. 5 shows C1=59 fF and C2=86 fF and thus, the difference between C1 and C2 is about 37%. In contrast, for the symmetric inductor of FIG. 2, the table of FIG. 5 shows C1=103.7 fF and C2=104.5 fF and thus, the difference between C1 and C2 is about 0.8%. This shows that the inductor in accordance with the present invention shown in FIG. 2, has nearly perfect symmetry, while the conventional inductor is substantially asymmetric.

In the electromagnetic simulation, the material used for the windings of the inductor was Au, but any other conductive materials may be used as well. The insulating material was a polyimide with a thickness of approximately 2 μm. However, silicon dioxide, silicon nitride, or any other insulating film would be acceptable proved that it can be realized with similar dimension of thickness. The thickness of the insulator was chosen to minimize the crossover capacitance and make the inductor more idea. Making the thickness of the dielectric thicker up to a point where it is as think as the width of the windings is advantageous. However, practical considerations typically limit the thickness to approximately four micrometers.

Having described the invention in connection with certain embodiments thereof, modifications will certainly suggest themselves to those skilled in the art. As such, the invention is not to be limited to the disclosed embodiments except as required by the appended claims.

1. An inductor comprising:
a plurality of windings, each one of the windings having a center, wherein each one of the windings of the plurality of windings has a different size compared to the other windings, the center of each one of the windings of the plurality of windings substantially coincides with the center of the other windings of the plurality of windings; and
at least a first conductor crossover conductively connecting one winding of the plurality of windings with another winding of the plurality of windings.

2. The inductor of claim 1 further comprising a second conductor crossover associated with at least one of said plurality of windings for conductively connecting at least one of said plurality of windings with yet another one of the plurality of windings, wherein the first and second conductor crossovers are disposed so as to preserve a symmetry of the inductor about an axis intersecting both the first and second conductor crossovers and the centers of the windings.

3. The inductor of claim 2 wherein the plurality of windings includes:
at least a relatively larger winding having a first portion and a second portion thereof;
at least a relatively smaller winding having a first portion and a second portion thereof; and
wherein the conductor crossovers each comprising a first conductor and a second conductor, the conductor crossover conductively connecting the relatively larger winding and the relatively smaller winding, wherein the first portion of the relatively larger winding is conductively connected to the second portion of the relatively smaller winding by the first conductor, and the first portion of the relatively smaller winding is conductively connected to the second portion of the relatively larger winding by the second conductor.

4. The inductor of claim 3, further comprising a first terminal and a second terminal, wherein the first terminal is conductively connected to the first portion of the relatively larger winding, and the second terminal is conductively connected to the second portion of the relatively larger winding.

5. The inductor of claim 4, further comprising a outer peripheral conductor, a size of the outer peripheral conductor being greater than the size of said relatively larger winding, wherein the center of said relatively larger winding and the center of the peripheral conductor substantially coincide, whereby the peripheral conductor is disposed outwardly of a periphery of the relatively larger winding and the outer peripheral conductor being generally symmetric with said relatively larger winding.

6. The inductor of claim 5, wherein the outer peripheral conductor defines a shape comprising an open curve, the open curve having a first end point and a second end point, the outer peripheral conductor further comprising a first ground terminal connected to the first end point and a second ground terminal connected to the second end point.

7. The inductor of claim 6, wherein the windings have a circular shape.

8. The inductor of claim 6, wherein the windings have a polygonal shape.

9. The inductor of claim 6, wherein the plurality of windings and the outer peripheral conductor are all co-planarly disposed on a substrate.

10. The inductor of claim 2 wherein the plurality of windings comprises:
an outer winding having a first portion and a second portion thereof, the size of the outer winding being greater than the size of the other windings;
an inner winding having a first portion and a second portion thereof, the size of the inner winding being smaller than the size of the other windings;
at least one middle winding having a first portion and a second portion thereof, a size of the at least one middle winding being smaller that the size of the outer winding and bigger than the size of the inner winding; and
a plurality of conductor crossovers conductively connecting adjacent windings, wherein each one of the conductor crossovers comprises a first conductor and a second conductor.

11. The inductor of claim 10, wherein:
the outer winding is disposed adjacent to an outer middle winding and is conductively connected thereto by an outer conductor crossover; and
the inner winding is disposed adjacent to an inner middle winding and is conductively connected thereto by an inner conductor crossover;
for any given middle winding other than the outer middle winding and the inner middle winding, the given middle winding is disposed adjacent a first middle winding having a bigger size than the given middle winding, and adjacent a second middle winding having a smaller size than the given middle winding, the given middle winding being conductively connected to the first middle winding by a first conductor crossover, the given middle winding being conductively connected to the second middle winding by a second conductor crossover.

12. The inductor of claim 11, wherein:
the first portion of the outer winding is conductively connected to a second portion of the outer middle winding by a first conductor of the outer conductor crossover, and the second portion of the outer winding is conductively connected to a first portion of the outer middle winding by a second conductor of the outer conductor crossover;
a first portion of the inner middle winding is conductively connected to the second portion of the inner winding by a first conductor of the inner conductor crossover, and a second portion of the inner middle winding is conductively connected to the first portion of the inner winding by a second conductor of the inner conductor crossover; and
a first portion of the given middle winding is conductively connected to a second portion of the second middle winding by a first conductor of the second conductor crossover, a second portion of the given middle winding is conductively connected to a first portion of the second middle winding by a second conductor of the second conductor crossover, the first portion of the given middle winding is conductively connected to a second portion of the first middle winding by a first conductor of the first conductor crossover, the second portion of the given middle winding is conductively connected to the first portion of the first middle winding by a second conductor of the first conductor crossover.

13. The inductor of claim 12, further comprising a first terminal and a second terminal, wherein the first terminal is conductively connected to the first portion of the outer winding, and the second terminal is conductively connected to the second portion of the outer winding.

14. The inductor of claim 13, further comprising a outer peripheral conductor, a size of the peripheral conductor being greater than the size of the outer winding, wherein the center of the outer winding and a center of the outer peripheral conductor substantially coincide, the outer peripheral conductor being disposed outwardly of the outer winding and being ohmically isolated from the outer winding within the inductor.

15. The inductor of claim 14, wherein the outer peripheral conductor has a shape which defines an open curve, the open curve having a first end point and a second end point, the peripheral conductor further comprising a first ground terminal connected to the first end point and a second ground terminal connected to the second end point.

16. The inductor of claim 15, wherein the windings have a circular shape.

17. The inductor of claim 15, wherein the windings have a polygonal shape.

18. A planer inductor comprising the inductor of claim 15, wherein the plurality of windings lie in a common plane.

19. An inductor having a plurality of windings, wherein each winding of the plurality of windings is symmetric about a center of the inductor, said plurality of windings being arranged in a common plane.

20. A method of winding an inductor, the method comprising the steps of:
providing a plurality of windings, each one of the windings having a center and said plurality of windings being generally symmetric about the center of the inductor, each one of the windings having a different size from the other windings;
disposing the windings such that the center of each one of the windings substantially coincides with the center of the other windings; and
conductively connecting each one of the windings to at least one adjacent winding through a conductor crossover.

21. The method of claim 20 wherein the conductor crossovers are aligned along an axis intersecting the conductor crossovers and the center of the inductor, so as to preserve a symmetry of the inductor about the axis.

22. The method of arranging windings of an inductor of claim 21, wherein the plurality of windings comprises:
an outer winding having a first portion and a second portion thereof;
an inner winding having a first portion and a second portion thereof, the size of the inner winding being smaller than the size of the outer winding; and
a conductor crossover comprising a first conductor and a second conductor, the conductor crossover conductively connecting the outer winding and the inner winding;
wherein the first portion of the outer winding is conductively connected to the second portion of the inner winding by the first conductor, and the first portion of the inner winding is conductively connected to the second portion of the outer winding by the second conductor.

23. The method of arranging windings of an inductor of claim 22, further comprising the steps of:
providing a first terminal and a second terminal;
conductively connecting the first terminal to the first portion of the outer winding; and
conductively connecting the second terminal to the second portion of the outer winding.

24. The method of arranging windings of an inductor of claim 23, further comprising the steps of:
providing a peripheral conductor, a size of the peripheral conductor being greater than the size of the outer winding, and the peripheral conductor being generally symmetric.
disposing the peripheral conductor at the periphery of the outer winding, adjacent the outer winding, such that the peripheral conductor is substantially concentric with the outer winding.

25. The method of arranging windings of an inductor of claim 24, wherein the shape of the peripheral conductor defines an open curve, the open curve having a first end point and a second end point, the peripheral conductor further comprising a first ground terminal connected to the first end point and a second ground terminal connected to the second end point.

26. The method of arranging windings of the inductor of claim 25, wherein the windings have a generally circular shape.

27. The method of arranging windings of an inductor of claim 25, wherein the windings have a generally polygonal shape.

28. A planer inductor comprising a plurality of windings, wherein the windings are arranged according to the method of claim 25, and wherein the plurality of windings a arranged in a planar configuration.
